(19) United States
(12) Patent Application Publication
(10) Pub. No.: US 2024/0244610 A1
(43) Pub. Date: Jul. 18, 2024

(54) SCHEDULING RADIO TRANSMISSIONS

(71) Applicant: Nordic Semiconductor ASA, Trondheim (NO)

(72) Inventor: Cedric HÖLZL, Trondheim (NO)

(73) Assignee: Nordic Semiconductor ASA, Trondheim (NO)

(21) Appl. No.: 18/412,064

(22) Filed: Jan. 12, 2024

(30) Foreign Application Priority Data
Jan. 17, 2023 (GB) 2300661.2

(51) Int. Cl. H04W 72/1263

(52) U.S. Cl. CPC H04W 72/1263

(57) ABSTRACT

A radio device is configured for radio communication as a master device over each of a plurality of connections between the master device and a respective plurality of slave devices. The radio device is configured to schedule radio transmissions over the connections. For each time period of a succession of time periods, it assigns to each of the connections a respective first time slot for radio transmissions between the radio device and the respective slave device, wherein the first time slots within the time period are non-overlapping and are all located within a first portion of the time period. In response to a request to provide additional time to a first connection, it assigns to the first connection an additional time allocation within a second portion of a time period of the succession of time periods, the second portion occurring after the first portion of the time period.

### CROSS REFERENCE TO RELATED APPLICATION

This application claims priority from Great Britain Application No. 2300661.2, filed Jan. 17, 2023, which application is incorporated herein by reference in its entirety.

### BACKGROUND OF THE INVENTION

This invention relates to methods, devices and software for scheduling radio transmissions between a master device and slave devices.

In some radio systems, such as cellular telecoms, a base station can transmit simultaneously with many devices at the same time, using orthogonal frequency division multiple access (OFDMA).

However, in other radio system, such as Bluetooth™ Low Energy (BLE), a master radio device (e.g. a BLE central device), is responsible for maintaining respective connections to a plurality of slave radio devices (e.g. BLE peripheral devices), but can transmit over at most one of the connections at a time. In such contexts, a challenge arises as to how the master device can best schedule data for transmission over the different connections.

In BLE, a master device assigns each connection a series of connection events. These provide opportunities for radio packets to be sent from, and optionally received by, the master device. These connection events start at anchor points that are spaced apart from each other by a connection interval assigned to the respective connection. The duration of a connection event can vary depending on how much data is queued for transmission over the respective connection.

However, it can be difficult for the master device to configure the timing offsets (i.e. anchor points) and durations of the connection events across multiple connection in order to schedule transmissions in such a way that bandwidth and latency requirements of the slave devices can be satisfied. This can be especially challenging where some of the slaves demand particularly low latency performance (i.e. requiring frequent opportunities to exchange data), or where the bandwidth and/or latency requirements of the connections fluctuate over time.

Embodiments of the present invention seek to provide approaches to scheduling radio transmissions that address this challenge.

### SUMMARY OF THE INVENTION

From a first aspect, the invention provides a radio device configured for radio communication as a master device over each of a plurality of connections between the master device and a respective plurality of slave devices, wherein the radio device is configured to schedule radio transmissions over the plurality of connections by:
for each time period of a succession of time periods, assigning to each of the plurality of connections a respective first time slot, within the time period, for radio transmissions between the radio device and the respective slave device, wherein the first time slots within the time period are non-overlapping and are all located within a first portion of the time period; and
in response to a request to provide additional time to a first connection of the plurality of connections, for radio transmissions between the master device and a first slave device of the plurality of slave devices, assigning to the first connection an additional time allocation within a second portion of a time period of the succession of time periods, the second portion occurring after the first portion of the time period.

From a second aspect, the invention provides a method of scheduling radio transmissions over a plurality of connections between a master device and a respective plurality of slave devices, the method comprising:
for each time period of a succession of time periods, assigning to each of the plurality of connections a respective first time slot, within the time period, for radio transmissions between the radio device and the respective slave device, wherein the first time slots within the time period are non-overlapping and are all located within a first portion of the time period; and
in response to a request to provide additional time to a first connection of the plurality of connections, for radio transmissions between the master device and a first slave device of the plurality of slave devices, assigning to the first connection an additional time allocation within a second portion of a time period of the succession of time periods, the second portion occurring after the first portion of the time period.

From a third aspect, the invention provides computer software comprising instructions which, when executed by a processor of a radio device, cause the radio device to schedule radio transmissions over a plurality of connections between the radio device, as a master device, and a respective plurality of slave devices, according to a method as disclosed herein.

Thus it will be seen that, in accordance with at least some embodiments of the invention, successive periods of time are divided into at least a first “initial” portion, in which every slave device has a guaranteed opportunity to communicate with the master device, and a second “extension” portion, in which one or more slave devices may be given additional time for exchanging (i.e. for sending and/or receiving) further data with the master device. In particular, providing these two portions in every time period can give each slave device a succession of opportunities to exchange information such as latency or throughput requirements with the master device, during the first portions, thus allowing the master device to efficiently schedule radio transmissions in the second portions so as to try to optimally meet the requested parameters for the slave devices. This approach can also enable the scheduling to change over time, e.g. from one period to the next, thereby enabling the radio system to respond promptly to changes in latency or throughput requirements of one or more of the radio devices.

The successive time periods may be contiguous time periods. They may all be of equal duration, for at least a plurality of time periods (however it's possible that later time periods could be of shorter or longer duration). The first portion and second portion of each time period may together contain all radio transmissions sent over the plurality of connections during the time period. The time period may have a duration equal to the first portion plus the second portion, optionally plus an inter-portion spacing. However, these features are not essential in all embodiments.

The first portions of the succession of time periods may all have a same first duration. The second portions may all have a same second duration. The second duration may be longer than the first duration, although this is not essential.

The first time slots may all have a same time-slot duration. Each connection may be assigned exactly one time slot in the first portion. The first time slots within a time period may fully occupy the first portion of the time period. Thus, in some embodiments, the first portion may have a duration equal to the number of slave devices multiplied by the time-slot duration. In this way, the first portion may last a minimal length of time required to give each slave device an opportunity for communication with the master device in each first portion.

The master radio device may be configured to transmit, to each slave device, data that identifies the respective first time slot that is assigned to the respective slave device.

In some embodiments, each connection is associated with a respective time series of connection events, regularly spaced apart by a respective connection interval. The series may span at least the first portion of a time period, and may span one or more complete time periods. Each connection event may provide a theoretical opportunity for data transmission; however, transmission may be prevented for some connection events, e.g. by using a subrating mechanism as described below. The connections may all use a common connection interval; in some embodiments, this may have a value between 7.5 milliseconds and 4 seconds (e.g. 7.5 milliseconds). The connection events may be aligned in time across all of the connections (i.e. starting at the same instants). This may advantageously facilitate a precise temporal alignment of radio transmissions over the different connections when using scheduling as disclosed herein. The common connection interval (i.e. its duration) may be communicated to each slave device by the master device.

The first time slots may be spaced within each first period at intervals equal to the common connection interval (e.g. with a new time slot every 7.5 ms). Each first time slot may have a duration equal to the common connection interval, and may correspond to (e.g. contain) a respective connection event. Each connection may be assigned a first time slot with a different respective time offset into the first portion that remains constant over a plurality of successive time periods. Thus, if these successive time periods have constant durations, the first times slot for any particular connection will occur at regular time intervals. This may help reduce the scheduling communication overhead.

The first portions may all have a first duration of a multiple of the common connection interval (e.g. n×7.5 ms, for some integer n>1). The duration may be the common connection interval multiplied by the number of connections. For at least said succession of time periods (i.e. for at least two or more successive time periods), the second portions may all have a respective second duration of one or more times the common connection interval (e.g. m×7.5 ms, for some integer m>0), which may or may not all be same duration. However, for some time periods, the second portion may have zero duration, but, in all embodiments, at least one time period has a second portion of non-zero duration. The durations of the first and second portions may change over time. However, at times they may remain constant for at least a plurality of successive time periods. This may reduce the scheduling communication overhead.

The master device and slave devices may be configured to exchange data using radio frequency hopping over a plurality of radio channels. Each connection may correspond to a respective time division of a shared radio medium (e.g. a shared frequency-hopping pattern). In some embodiments, the master device is a Bluetooth™ Low Energy (BLE) device and the plurality of connections are Bluetooth™ Low Energy (BLE) connections. However, this is not essential in all embodiments, and the principles disclosed herein may be advantageously applied to other proprietary or standardised radio protocols in some embodiments.

The master device may be configured to assign the first connection the additional time allocation within the second portion by assigning to the first slave device a set of one or more connection events (i.e. second time slots) within the second portion corresponding to the additional time allocation. The assigned set may cover the whole second portion or only a fraction of the second portion. The master device may communicate the assignment of the additional time allocation to the first slave device by one or more radio messages sent from the master device to the first slave device. The master device may indicate the set of assigned connection events by sending subrating data comprising one or more subrating parameters to the first slave device that instruct the first slave device to use (i.e. receive and optionally transmit during) each of the assigned connection events. The subrating data may comprise one or more subrate factors and/or one or more subrate base events and/or one or more continuation numbers. A subrate factor may be an integer value, k, that instructs the slave device to use only every k^{th} connection event. A subrate base event may be an integer value that indicates to the slave device a connection event at which to start applying the subrate factor. A continuation number may be an integer value, c, that instructs the slave device to also use the next c connection events after each k^{th} connection event.

The master device may additionally control each of the other slave devices not to use the connection events assigned to the first slave device. It may do this by sending respective subrating data to one or more or all of the other slave devices. This may be sent during the initial period and/or during the extension period.

In embodiments that use BLE connections, the master device may communicate the additional time allocated to the first slave device by sending data to the first slave device, and optionally to one or more or all of the other slave devices, according to a BLE subrating mechanism. The slave devices may thus advantageously be assigned time in the extension portions of the time periods using existing BLE protocols, without the need for proprietary signalling. The master device may be configured to send LL_SUBRATE_IND packets to the plurality of slave devices. It may be configured to determine the contents of one or more of the LL_SUBRATE_IND packets to send to a slave device at least in part in accordance with one or more first time slots assigned to the slave device. It may determine the contents of one or more of the LL_SUBRATE_IND packets to send to the first slave device at least in part in accordance with the assigned additional time allocation. It may send such a LL_SUBRATE_IND packet in response to a LL_SUBRATE_REQ packet received from the respective slave device or in response to a request from another component within the master device.

The master device may be configured to process, for one time period, a plurality of requests to provide additional time to each of a respective plurality of the connections. Such multiple requests may occur for some time periods and not for others, depending on the slave device requirements. The master device may be configured to respond to each request by either declining the request or by assigning a respective additional time allocation within the second portion of the one time period.

In a first set of embodiments, the master device may be configured, for each time period, to assign all of the connection events of the time period to a single respective connection. It may decline any further requests for that time period.

In a second set of embodiments, the master device may be configured to assign a further respective additional time allocation, within the second portion of the time period, as a respective contiguous sequence of one or more connection events, to each of the plurality of connections for which requests were received, optionally up to a maximum number of connections. Assigning each such connection a respective single span of time within the second portion may advantageously place a relatively low processing burden on the master device. The respective sequences of connection events (corresponding to respective spans of time) may all have a same duration, to within plus or minus one connection event. This may ensure a fair allocation of time across the connections that have requested additional time. However, in some situations, the sequences of connection events assigned to the connections may have different durations (e.g. responsive to different latency and/or bandwidth requirements for the different connections). Each assigned sequence of connection events may be communicated to the respective slave device by the master device transmitting subrating data to the slave devices.

In a third set of embodiments, the master device may be configured to assign a further respective additional time allocation, within the second portion of the time period, to each of the plurality of connections for which requests were received, optionally up to a maximum number of connections, wherein at least one of the additional time allocations comprises two or more non-contiguous sets of connection events. This may enable the master device to determine a more sophisticated scheduling pattern within the second portion that may better satisfy the latency and throughput requirements of the slave devices. However, it may consume greater processing resources on the master device.

The master device may be configured to receive the request to provide additional time to the first connection by radio from the first slave device. It may receive the request during the first portion of a time period, e.g. during the first time slot assigned to the first slave device. The master device may be configured to receive the request by receiving, from the first slave device, a subrating request message (e.g. a BLE LL_SUBRATE_REQ packet) and/or by receiving, from the first slave device, a request to exchange more data contained in a header of a radio packet (e.g. a “More Data, MD” bit of a BLE Data Physical Channel PDU). The slave devices may be configured to send such requests during their respective assigned first time slot when they desire additional time.

However, the master device may alternatively or additionally be configured to generate the request to provide additional time to the first connection within the master device, or to receive it from elsewhere. For example, in some embodiments, a software component such as a host-layer or application-layer component executing within the master device may generate the request, which may be received by a hardware or software scheduler component within the master device.

The master radio device may be configured to transmit at least one respective data packet to a respective slave device in each assigned first time slot The master device may be configured for receiving one or more data packets from a respective slave device in each assigned first time slot. However, the master device need not necessarily actually receive a data packet from every slave device in every time period, as a slave device might not respond if it has no message data to send.

The radio device may be configured to operate as a master device to the plurality of slave devices, and also to operate, at the same time or at a different time, as a slave device to one or more other master devices.

The radio device may be any electrical device, such as a wireless sensor, audio appliance, laptop computer, etc., or it may be a component for use within a larger appliance. In some embodiments it is an integrated circuit, such as a system-on-chip (SoC) or a radio-on-a-chip. It may include an antenna or may comprise an interface for connection to an external antenna. It may comprise interfaces for connection to other external components that may be required for the device to operate, such as a power supply, or a power amplifier, or a crystal oscillator, etc.

Features of any aspect or embodiment described herein may wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1 is a schematic drawing of a radio system embodying the invention;

FIG. 2 is a schematic drawing of the master device of the radio system;

FIG. 3 is a timing diagram showing periodic initial and extension periods as used in scheduling methods embodying the invention;

FIG. 4 is a timing diagram for five radio connections being scheduled according to methods embodying the invention, having an empty extension period;

FIG. 5 is a timing diagram for five radio connections being scheduled according to methods embodying the invention, in which an extension period is used by a single connection;

FIG. 6 is a timing diagram for five radio connections being scheduled according to methods embodying the invention, in which an extension period is used by two connections; and

FIG. 7 is a timing diagram for five radio connections being scheduled according to methods embodying the invention, in which an extension period is shared across four connections.

### DETAILED DESCRIPTION

FIG. 1 shows a radio system 100 comprising a master device 102 (which may also be called a central device) and three slave devices 104, 106, 108 (which may also be called peripheral devices) that can exchange data with the master device 102 over three respective data connections. The devices 102-108 communicate using the same radio protocol, which in some examples is Bluetooth™ Low Energy (BLE). Each device 102-108 may be a static or mobile electronic device such as a wireless sensor, a domestic appliance, a vehicle, a personal computer, a cellular telephone, etc. Each device 102-108 may include a processor and memory storing software instructions for execution by the processor. Each may include a radio transceiver, e.g. provided as a radio-on-a-chip, and an antenna, and other components for radio transmission and reception. Any of the operations disclosed herein may be implemented in hardware (e.g. by dedicated analog and/or digital circuitry) or in software, or in any appropriate combination of hardware and software.

According to the protocol, the master device can use (i.e. transmit or receive over) only one of these connections at a time, and the master device 102 is responsible for coordinating access to the radio medium. It does so in a time-multiplexed manner by periodically polling each of the slave devices 104-108 in turn. The connection to each slave device 104-108 is assigned a respective connection interval, which is the time between successive regular connection events. Each connection event provides an opportunity for the master device 102 to exchange data with a respective slave device 104-108. Specific connection events may also be referred to as connection instants. Multiple packets may be transferred to and from a slave device 104-108 during one connection event. Each connection event normally contains at least one packet sent by the master device 102. However, the master device 102 may fail to transmit in a connection event at all on occasions, e.g. due to scheduling conflicts or if a subrating factor is being used. The amount of data that can be exchanged with a slave 104-108 during a connection event can vary, but, when the master device 102 is connected to multiple slaves 104-108, it is constrained by the timing of the next connection event for a different one of the slaves 104-108. The relative positions of the starts of the connection events (referred to as anchor points in BLE) across the different peripheral connections will affect the maximum duration of the connection events for each connection, and thus the potential throughput of each connection.

In BLE, connection intervals can range from 7.5 ms to 4 secs, in increments of 1.25 ms. The data connection is established with a connection interval parameter value set by the master device 102. A slave 104-108 may request a different value, but the master device 102 has the final say in the value, and may choose an interval that is closer to a requested value, but still not equal to it. The slave devices 104-108 may also signal to the master device 102 a minimum and/or maximum connection interval for a connection to the slave. The ability to change the connection interval dynamically enables the throughput speed of a data connection to be changed according to changing circumstances. A long connection interval value (e.g. 4 seconds) can lead to lower power consumption, but reduced data throughput and higher latency compared with a shorter connection interval.

Subrating is an optional mechanism in BLE that can be used to allow a connection to switch rapidly between a fast duty cycle, defined by the underlying connection interval for the connection, and a slower duty cycle, in which only a subset of the nominal connection events assigned to the connection are actually used by the slave device for exchanging data with the master device 102. A slower duty cycle can be specified using the following properties of a connection: subrate factor, subrate base event, and continuation number. The subrate factor, k, instructs the slave device to use only every k^{th} connection event. The subrate base event parameter indicates to the slave device from which connection instant to start applying the subrate factor—i.e. it determines the phase of the subrated events. The continuation number, c, instructs the slave device to also use (i.e. not skip) the next c connection events after each k^{th} connection event. The peripheral latency parameter can also influence which connection events are listened to by the slave when using subrating, as a non-zero value allows the slave device to save power by not listening to that number of successive non-continuation subrated connection events.

Conventionally, subrating is used to enable a particular BLE connection to be transitioned quickly between two different duty rates. However, the present disclosure uses subrating in a novel and sophisticated way to enable a master device 102 to efficiently coordinate radio communications over a plurality of connections to different slave devices 104-108 so as to better meet the varying bandwidth and latency requirements of the different slave devices 104-108.

The master device 102 can receive bandwidth and latency requirements or preferences from the slave devices 104-108, using known BLE messaging, and/or from application-layer or link-layer components executing within the master device 102. It uses this information to manage the scheduling of transmissions to and from the slave devices 104-108, during the respective connection events, over the various connections. This is not straightforward, especially as the master device 102 does not necessarily know what each connection will be used for, e.g. at an application level, and so cannot necessarily anticipate how much data will need to be transmitted to and/or received from each slave 104-108 in any given period.

The master device 102 here addresses this challenge by using subrating to schedule transmission opportunities for the connections over a succession of concurrent time periods, each of which is divided into a first “initial” portion followed by a second “extension” period. There may be some spacing between the portions, where no transmissions occur; however all transmissions over the connections occur within one of these periods. The initial portion gives every slave device 104-108 associated with the master device 102 one connection event, while the extension portion can allow additional time to be allocated to one or more slave device 104-108 where appropriate. The time allocations in both portions are managed by adjusting subrating parameters so as to allow the devices to rapidly implement revised allocations, from time period to time period, while using existing BLE over-the-air protocol data units (PDUs). This allows any slave devices 104-108 to benefit from this efficient scheduling algorithm, so long as all the slave devices 104-108 support subrating, without the slaves 104-108 having to be specially configured in any way. Instead, the master device 102 can manage the novel scheduling.

Some exemplary implementations of scheduling algorithms are described in more detail further below.

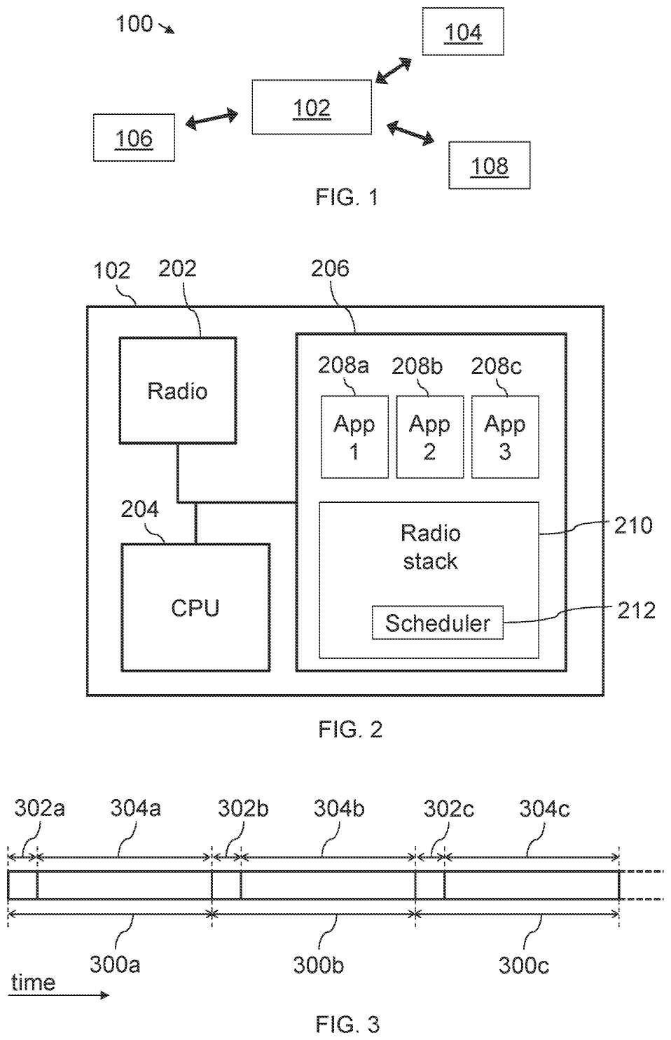

FIG. 2 shows some of the internal components of an exemplary master device 102. The master device 102 may be a complete device, such as a wireless sensor, cellular phone, etc., including a power supply, but it may be a system-on-chip, e.g. for integration into a more complex device. It includes a radio transceiver 202 (e.g. a BLE radio) which is controlled by a central processing unit (CPU) 204 that executes software stored in a memory 206. The memory 206 may store software, data, parameters, etc. In the present example, the memory 206 stores three software applications 208a, 208b, 208c that all make use of the radio 202 to communicate with the respective slave devices 104, 106, 108. The applications 208a-c send and receive data over the radio connections through firmware implementing a radio stack 210 (e.g. a BLE stack).

The firmware includes within it a scheduler 212 component which can receive transmission tasks from a higher level within the radio stack 210 (e.g. a host layer) in response to the communication requirements of the applications 208a-c. The applications 208a-c and/or slave devices 104-108 may have requirements for throughput and/or latency that differ between the connections, and which may also change over time. These requirements are communicated to the radio stack 210 where they are used to control the connection scheduling, e.g. as described below, in order to provide a desired quality of service (QoS).

FIG. 3 illustrates how the scheduler 212 divides time into a succession of time periods 300a, 300b, 300c, etc., where each time period 300a-c consists of an initial portion 302a-c which is followed immediately by an extension portion 304a-c. The initial portions 302 have a duration that scales with the number of connections the master device 102 currently has open (e.g. three in the example of FIG. 1, but sometimes higher or lower than this). The extension portions 304 could all have a common, fixed duration, but this is not essential and the master device 102 may set different durations over time, e.g. in response to changing bandwidth requirements.

The subrating-based scheduling in the present example implements the same connection interval across all of the connections and throughout the time periods 300a-c. For optimal responsiveness, by increasing the granularity of the “extension” portion, and to minimise the overhead of the initial portion, this may be as short as possible; e.g. 7.5 ms. However, a shorter connection interval may potentially increase scheduling complexity, so this it may be longer in some embodiments. It may potentially range from 7.5 ms to 4 secs.

The scheduler 212 also allocates a subrating offset to each connection that are successive multiples of the connection interval (e.g. 0 ms, 7.5 ms and 15 ms, in the case of three connections). However the principal anchor-point offset for each connection is set to 0 to ensure the start of the “extension” portion lines up across the connections; instead, the subrating mechanism is used to generate these first time-slot offsets. The scheduling algorithm in this example assumes all the connections have a latency requirement of at least the connection interval multiplied by the number of connections (e.g. of at least 22.5 ms, for three connections).

In some examples, each extension portion lasts for T=N·7.5 ms, where N is the number of connections. However, extension portions may be shorter or longer than this and may last any multiple of 7.5 ms, ranging from zero to multiple seconds. During the extension portions 304 only connections for which the scheduler 212 has reserved one or more time slots may use the radio, where each time slot has a duration equal to the connection interval (e.g. 7.5 ms).

The timing of the connection events is determined by the following parameters: connection interval (connInterval), subrate base event (connSubrateBaseEvent), subrate factor (connSubrateFactor), continuation number (connContinuationNumber), and peripheral latency (connPeripheralLatency). The scheduler 212 configures and, over time, modifies these parameters for each connection so as to instruct the slave devices 104-108 to use exactly one connection event (e.g. of minimal 7.5 ms duration) in the initial portion, and then to implement a calculated pattern of assignments of time slots, each equal to one connection interval, to connections in the extension portion 304. In any particular extension portion, there may be zero, one or more selected slave devices 104-108 that are instructed to listen for connection events from the master device 102 within that extension portion.

During each initial portion, each connection can freely exchange protocol data units (PDUs)—i.e. radio packets—within its assigned connection event. However, before the end of the connection event, if the slave device desires to be allocated additional time, it should send a LL_SUBRATE_REQ PDU. The master device 102 can respond with a LL_SUBRATE_IND PDU containing updated subrate factor, subrate base event, peripheral latency and continuation number values. Some legacy slave devices may do this even without being specially configured to support the present scheduling methodologies, but other slave devices may be configured to do this at the appropriate time. However, even if the slave devices 104-108 do not all do this, the master device 102 may be able to send an unsolicited LL_SUBRATE_IND PDUs to a slave, before the end of the initial-portion connection events, with revised subrating parameters for the extension portion, if the master device 102 determines that the slave should be allocated additional time.

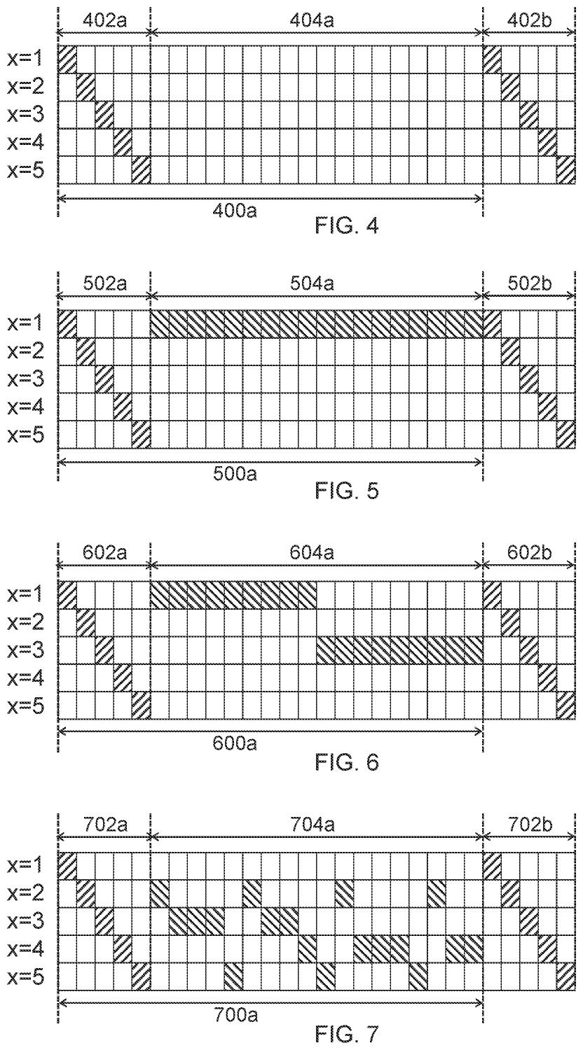

FIG. 4 shows an example scheduling for a first time period 400a, containing an initial portion 402a and an extension period 404a. The initial portion 402b of a subsequent time period is also shown. The vertical axis shows five connections, x=1, . . . , 5, between a master device and five slave devices, while the horizontal time axis is divided into 7.5 ms intervals, such that each of the time slots has a duration of 7.5 ms corresponding to one connection interval, as set by the master device. The extension portion 404a in this example has a duration of 18×7.5 ms=135 ms.

It can be seen that each connection is allocated one time slot (i.e. one connection event) in the initial portion 402a. In this particular example, no time is shown as allocated to any of the connections in the extension portion 404a. However this will not always be the case.

FIGS. 5, 6 and 7 show three different types of time-slot assignment. One master device may implement just one of these approaches, or may be able to support one, two or all three approaches, e.g. selecting which of them to use depending on circumstances.

FIG. 5 illustrates an approach of always allocating the entirety of every extension period to at most one connection. In this example, an extension period 504a has been assigned to the first connection, x=1. This has an advantage of allowing a single connection full access without switching, and is relatively simple to implement, without any overhead from connection switching within the extension period. In particular, only the first connection, x=1, needs to be sent revised subrating information at the end of the initial portion 502a and again at the end of the extension portion 504a; the other connections can carry the same subrating parameters into the next first portion 502b. However, it is less flexible.

FIG. 6 illustrates an approach of sharing the extension period between a number of connections in respective spans of time of approximately equal duration (e.g. to within plus or minus one time slot). In this example, an extension period 604a has been divided equally between the first connection, x=1, and the third connection, x=3, with each getting a span of nine time slots. This approach may reduce potential latency compared with the first approach by reducing wait time before a connection can send or receive data. It remains relatively straightforward computationally for the master device to implement. However, the overhead may increase with the number of connections that share a single extension portion. The maximum number that can share one extension period might be capped in some embodiments. It may be limited to a predetermined fixed number, or the maximum number may be configurable e.g. by an application or host component of the radio device.

FIG. 7 illustrates a third approach in which a complex assignment of time slots is possible across multiple connections within a single extension portion 704a without requiring evenly split spans. Instead each 7.5 ms time slot can be assigned individually, thus enabling maximum granularity. This comes at the cost of added computational complexity due to requiring arbitration on slot assignment between different tasks, as well as greater communication overhead—e.g. potentially involving transmitting revised subrating parameters to the slave devices multiple times during the course of the extension period 704a. However it allows low latency tasks to book slots first, at appropriate intervals to ensure quality of service, while allowing other more latency-tolerant connections to be scheduled in the remaining slots. It can thus better satisfy the latency and throughput wishes of multiple slave devices.

In all these approaches, the assignment of time slots in the extension portion can change from one time period to the next (although it doesn't always have to). In approaches, such as the first approach, where a slave device may be denied access to the extension portion in a first time period, that slave device may then be granted access in a later time period. In the first two approaches, the master device may implement a circular queue to assign time to the connections over successive time periods in turn to ensure fairness among them. However a more complex logic algorithm, such as deficit round robin, may be used with the third approach to provide fairness among the connections—e.g. to prevent one from reserving all the slots in an extension period.

The master device may receive a request for additional time for one or more connections over the radio within a connection event in the initial portion of a time period, and may seek to provide this within the extension portion of the same time period. However, this may not always be possible—e.g. if multiple slave devices request additional time—in which case time may be assigned in a later extension period, e.g. using a queueing approach. A request for additional time may alternatively originate from the master device, e.g. from an application 208 executing within the master device 102.

A host or application may in some embodiments also be able to control the operation of the scheduler 212 in other ways, e.g. specifying a duration for the extension portions. This may be done through a custom Bluetooth™ Host Controller Interface (HCI) command.

In some embodiments, during the initial portions, connections may be able to notify each other and decide on slot reservations if required. The notification may be on a host or application layer, by informing the peer device through data PDUs, or may be implemented by measuring the “MD” header bit in the link layer (“MD” denotes “More Data” and is traditionally used in BLE to inform a peer device that there is more data to be transmitted).

Traditionally in BLE, connections have to listen and be active on each connection event in order to listen and/or send data, regardless of actual existence of such data. This has the drawback of using power and adding noise to the radio environment when it may not even be required. The subrating-based scheduling disclosed herein can avoid this problem. It can also minimize latency by providing connections with a guaranteed slot in the “initial” portion, while also allowing connections (e.g. the slave device or the master device) to request additional radio time based on data volume, e.g. using a control PDU. This can reduce power consumption while providing greater flexibility than traditional scheduling.

Although these examples have been described in the context of BLE, it will be appreciated that the same approach may be advantageously used in other current or future protocols, which may be standardised or proprietary. If the protocol already has an equivalent subrating mechanism, this may be employed to efficiently communicate the scheduling information, but if not then new radio commands may be provided for communicating the time slots assignments from the master device to the slave devices.

It will be appreciated by those skilled in the art that the invention has been illustrated by describing one or more specific embodiments thereof, but is not limited to these embodiments; many variations and modifications are possible, within the scope of the accompanying claims.

1. A radio device configured for radio communication as a master device over each of a plurality of connections between the master device and a respective plurality of slave devices, wherein the radio device is configured to schedule radio transmissions over the plurality of connections by:
for each time period of a succession of time periods, assigning to each of the plurality of connections a respective first time slot, within the time period, for radio transmissions between the radio device and the respective slave device, wherein the first time slots within the time period are non-overlapping and are all located within a first portion of the time period; and
in response to a request to provide additional time to a first connection of the plurality of connections, for radio transmissions between the master device and a first slave device of the plurality of slave devices, assigning to the first connection an additional time allocation within a second portion of a time period of the succession of time periods, the second portion occurring after the first portion of the time period.

2. The radio device of claim 1, wherein the time periods of the succession of time periods are contiguous time periods of equal duration.

3. The radio device of claim 1, wherein the first portion and second portion of each time period of the succession of time periods together contain all radio transmissions sent over the plurality of connections during the time period.

4. The radio device of claim 1, wherein the first portions of the succession of time periods all have a same first duration and the second portions all have a same second duration, wherein the second duration is longer than the first duration.

5. The radio device of claim 1, wherein the first time slots all have a same time-slot duration, and wherein, for each time period, the first time slots within the time period fully occupy the first portion of the time period.

6. The radio device of claim 1, wherein, for each time period, each connection is assigned exactly one time slot in the first portion of the time period.

7. The radio device of claim 1, further configured to transmit, to each slave device, data that identifies the respective first time slot that is assigned to the respective slave device.

8. The radio device of claim 1, wherein each connection is associated with a respective time series of connection events, spanning the succession of time periods, wherein the connection events are regularly spaced apart by a common connection interval, and wherein the connection events are aligned in time across all of the connections.

9. The radio device of claim 8, wherein the first time slots are spaced within each first period at intervals equal to the common connection interval and wherein each first time slot has a duration equal to the common connection interval.

10. The radio device of claim 8, wherein each connection is assigned a first time slot with a different respective time offset into the first portion, wherein the respective time offset remains constant over the succession of time periods.

11. The radio device of claim 8, wherein the first portions all have a first duration of the common connection interval multiplied by the number of connections, and wherein each second portion has a duration of one or more times the common connection interval.

12. The radio device of claim 8, configured to assign the first connection the additional time allocation within the second portion by assigning to the first slave device a set of one or more connection events within the second portion corresponding to the additional time allocation.

13. The radio device of claim 12, configured to communicate the assignment of the additional time allocation to the first slave device by radio by sending subrating data comprising one or more subrating parameters to the first slave device, wherein the subrating data instructs the first slave device to use each of the assigned connection events.

14. The radio device of claim 1, configured to receive the request to provide additional time to the first connection by radio from the first slave device.

15. The radio device of claim 1, wherein the radio device is a Bluetooth™ Low Energy device and is configured to send LL_SUBRATE_IND packets to the plurality of slave devices, and wherein the radio device is further configured to determine the contents of a LL_SUBRATE_IND packet to send to the first slave device at least in part in accordance with the assigned additional time allocation within the second period of the time period.

16. The radio device of claim 1, configured, for each time period, to assign all of the connection events of the time period to a single respective connection.

17. The radio device of claim 1, configured to process requests to provide additional time to each of a respective plurality of the connections, and to assign a further respective additional time allocation, within the second portion of the time period, to each of a plurality of connections for which requests to provide additional time were received, optionally up to a maximum number of connections.

18. The radio device of claim 17, wherein each connection is associated with a respective time series of connection events, spanning the succession of time periods, wherein the connection events are regularly spaced apart by a common connection interval, and wherein the radio device is configured to assign each additional time allocation within the second portion as a respective contiguous sequence of one or more connection events, wherein all the assigned sequences of connection events within the second portion have a same duration to within plus or minus one connection event.

19. A method of scheduling radio transmissions over a plurality of connections between a master device and a respective plurality of slave devices, the method comprising:
for each time period of a succession of time periods, assigning to each of the plurality of connections a respective first time slot, within the time period, for radio transmissions between the master device and the respective slave device, wherein the first time slots within the time period are non-overlapping and are all located within a first portion of the time period; and
in response to a request to provide additional time to a first connection of the plurality of connections, for radio transmissions between the master device and a first slave device of the plurality of slave devices, assigning to the first connection an additional time allocation within a second portion of a time period of the succession of time periods, the second portion occurring after the first portion of the time period.

20. A non-transitory computer-readable medium comprising instructions which, when executed by a processor of a radio device, cause the radio device to schedule radio transmissions over a plurality of connections between the radio device, as a master device, and a respective plurality of slave devices, by:
for each time period of a succession of time periods, assigning to each of the plurality of connections a respective first time slot, within the time period, for radio transmissions between the radio device and the respective slave device, wherein the first time slots within the time period are non-overlapping and are all located within a first portion of the time period; and
in response to a request to provide additional time to a first connection of the plurality of connections, for radio transmissions between the master device and a first slave device of the plurality of slave devices, assigning to the first connection an additional time allocation within a second portion of a time period of the succession of time periods, the second portion occurring after the first portion of the time period.
